(19) United States
(12) Patent Application Publication
(10) Pub. No.: US 2024/0273521 A1
(43) Pub. Date: Aug. 15, 2024

(54) Method, System, and Computer Program Product for Generating a Single-Use Digital Asset

(71) Applicant: Visa International Service Association, San Francisco, CA (US)

(72) Inventors: Gregory Billington, San Francisco, CA (US); Bryce Jurss, Leander, TX (US); Todd Andrew Wade, San Mateo, CA (US)

(21) Appl. No.: 18/108,898

(22) Filed: Feb. 13, 2023

(51) Int. Cl. G06Q 20/38; G06Q 20/02; G06Q 20/06

(52) U.S. Cl. CPC G06Q 20/3829; G06Q 20/02; G06Q 20/065; G06Q 2220/00

(57) ABSTRACT

Provided is a method for generating a single-use digital asset. The method may include receiving a first instruction to exchange a selected amount of a cryptocurrency from a buyer account for a digital asset from a seller account. A second instruction to transfer the digital asset from the seller account may be transmitted. A third instruction to transfer the cryptocurrency from the buyer account may be transmitted. A smart contract may be generated within a first blockchain network. The cryptocurrency may be transferred from the buyer account, and the digital asset may be transferred from the seller account to the smart contract. The cryptocurrency may be transferred from the smart contract to the seller account. A non-retrievable address may be generated. The digital asset may be transferred from the smart contract to the non-retrievable address. Systems and computer program products are also provided.

### BACKGROUND

### 1. Field

The present disclosure relates generally to methods, systems, and computer program products for facilitating digital assets and, in some embodiments or aspects, to a method, system, and computer program product for generating a single-use digital asset.

### 2. Technical Considerations

Blockchain technology may facilitate blockchain networks executing on a computer network (e.g., a computer network of distributed client devices) to serve as one or more ledgers (e.g., distributed ledgers). A blockchain network may execute transactions using smart contracts (e.g., software instructions that may execute transactions). The blockchain network may document the transactions that are executed via smart contracts by generating blocks including data associated with transactions. Data associated with a transaction may be stored in a block within the blockchain. The blockchain network may include one or more blocks. Each block within the blockchain network (e.g., each block on the blockchain) may include (e.g., record) data associated with a transaction (e.g., data associated with a unique transaction). For example, a block may include one or more cryptographic hashes, a timestamp, an amount of digital currency and/or a digital asset, and/or the like. Digital currency and/or digital assets may allow for users (e.g., user of client devices) to complete digital transactions.

However, blocks within a blockchain network may not be changed, tampered with, edited, and/or destroyed. Therefore, data associated with transactions existing in one or more blocks on a blockchain network cannot be destroyed and/or edited. In some instances, data associated with transactions including digital assets may be memorialized in one or more blocks of the blockchain network. The digital assets may include a usage right to the digital asset (e.g., a perpetual usage right). In some instances, when a digital asset is included in a transaction on the blockchain network, the digital asset will pass from a first owner to a second owner. Sometimes, an owner of a digital asset may prove their ownership over a digital asset by possessing and/or using a private key (e.g., a private key of a public/private key pair).

### SUMMARY

Accordingly, it as an object of the present disclosure to provide methods, systems, and computer program products for generating a single-use digital asset that overcome some or all of the deficiencies identified above.

According to non-limiting embodiments or aspects, provided is a computer-implemented method for generating a single-use digital asset. An example method may include receiving, with at least one processor, a first instruction to exchange a selected amount of a cryptocurrency from a buyer account for a digital asset from a seller account. The method may include transmitting, with at least one processor, a second instruction to transfer the digital asset from the seller account. The method may include transmitting, with at least one processor, a third instruction to transfer the selected amount of the cryptocurrency from the buyer account. The method may include generating, with at least one processor, a smart contract within a first blockchain network associated with the cryptocurrency based on the second instruction to transfer the digital asset and the third instruction to transfer the selected amount of cryptocurrency. The method may include transferring, with at least one processor, the selected amount of the cryptocurrency from the buyer account and the digital asset from the seller account to the smart contract. The method may include transferring, with at least one processor, the selected amount of the cryptocurrency from the smart contract to the seller account. The method may include generating, with at least one processor, a non-retrievable address. The method may include transferring, with at least one processor, the digital asset from the smart contract to the non-retrievable address.

In some non-limiting embodiments or aspects, the method further may include generating, with at least one processor, a confirmation message indicating that the digital asset was transferred to the non-retrievable address and/or transmitting, with at least one processor, the confirmation message to the buyer account.

In some non-limiting embodiments or aspects, transferring the selected amount of the cryptocurrency from the smart contract to the seller account may include determining that the smart contract has a sufficient amount of the cryptocurrency to transfer to the seller account and/or transferring a portion of the selected amount of the cryptocurrency from the smart contract to the seller at each recurring period of a plurality of recurring periods within a duration.

In some non-limiting embodiments or aspects, transferring the selected amount of the cryptocurrency from the smart contract to the seller account may include executing the smart contract within the first blockchain network associated with the cryptocurrency.

In some non-limiting embodiments or aspects, the smart contract may be associated with a target time period. The target time period may include a duration of time from a first time that the smart contract may be generated to a second time that the smart contract may be executed.

In some non-limiting embodiments or aspects, the non-retrievable address may include an address on a second blockchain network.

In some non-limiting embodiments or aspects, the non-retrievable address may include a public address associated with the first blockchain network. Generating the non-retrievable address may include generating the public address and a private key associated with the public address and/or discarding the private key.

According to non-limiting embodiments or aspects, provided is a system for generating a single-use digital asset. An example system may include at least one processor programmed or configured to receive a first instruction to exchange a selected amount of a cryptocurrency from a buyer account for a digital asset from a seller account. The processor(s) may be programmed or configured to transmit a second instruction to transfer the digital asset from the seller account. The processor(s) may be programmed or configured to transmit a third instruction to transfer the selected amount of the cryptocurrency from the buyer account. The processor(s) may be programmed or configured to generate a smart contract within a first blockchain network associated with the cryptocurrency based on the second instruction to transfer the digital asset and the third instruction to transfer the selected amount of cryptocurrency. The processor(s) may be programmed or configured to transfer the selected amount of the cryptocurrency from the buyer account and the digital asset from the seller account to the smart contract. The processor(s) may be programmed or configured to transfer the selected amount of the cryptocurrency from the smart contract to the seller account. The processor(s) may be programmed or configured to generate a non-retrievable address. The processor(s) may be programmed or configured to transfer the digital asset from the smart contract to the non-retrievable address.

In some non-limiting embodiments or aspects, the processor(s) may be further programmed or configured to generate a confirmation message indicating that the digital asset was transferred to the non-retrievable address and/or transmit the confirmation message to the buyer account.

In some non-limiting embodiments or aspects, when transferring the selected amount of the cryptocurrency from the smart contract to the seller account, the processor(s) may be programmed or configured to determine that the smart contract has a sufficient amount of the cryptocurrency to transfer to the seller account and/or transfer a portion of the selected amount of the cryptocurrency from the smart contract to the seller at each recurring period of a plurality of recurring periods within a duration.

In some non-limiting embodiments or aspects, when transferring the selected amount of the cryptocurrency from the smart contract to the seller account, the processor(s) may be programmed or configured to execute the smart contract within the first blockchain network associated with the cryptocurrency.

In some non-limiting embodiments or aspects, the smart contract may be associated with a target time period. The target time period may include a duration of time from a first time that the smart contract may be generated to a second time that the smart contract may be executed.

In some non-limiting embodiments or aspects, the non-retrievable address may include an address on a second blockchain network.

In some non-limiting embodiments or aspects, the non-retrievable address may include a public address associated with the first blockchain network. In some non-limiting embodiments or aspects, when generating the non-retrievable address, the processor(s) may be programmed or configured to generate the public address and a private key associated with the public address and/or discard the private key.

According to non-limiting embodiments or aspects, provided is a computer program product for generating a single-use digital asset. An example computer program product may include at least one non-transitory computer readable medium including one or more instructions that, when executed by at least one processor, cause the at least one processor to receive a first instruction to exchange a selected amount of a cryptocurrency from a buyer account for a digital asset from a seller account. The one or more instructions, when executed by the processor(s), may cause the processor(s) to transmit a second instruction to transfer the digital asset from the seller account. The one or more instructions, when executed by the processor(s), may cause the processor(s) to transmit a third instruction to transfer the selected amount of the cryptocurrency from the buyer account. The one or more instructions, when executed by the processor(s), may cause the processor(s) to generate a smart contract within a first blockchain network associated with the cryptocurrency based on the second instruction to transfer the digital asset and the third instruction to transfer the selected amount of cryptocurrency. The one or more instructions, when executed by the processor(s), may cause the processor(s) to transfer the selected amount of the cryptocurrency from the buyer account and the digital asset from the seller account to the smart contract. The one or more instructions, when executed by the processor(s), may cause the processor(s) to transfer the selected amount of the cryptocurrency from the smart contract to the seller account. The one or more instructions, when executed by the processor(s), may cause the processor(s) to generate a non-retrievable address. The one or more instructions, when executed by the processor(s), may cause the processor(s) to transfer the digital asset from the smart contract to the non-retrievable address.

In some non-limiting embodiments or aspects, the one or more instructions that cause the processor(s) to transfer the selected amount of the cryptocurrency from the smart contract to the seller account cause the processor(s) to determine that the smart contract has a sufficient amount of the cryptocurrency to transfer to the seller account and/or transfer a portion of the selected amount of the cryptocurrency from the smart contract to the seller at each recurring period of a plurality of recurring periods within a duration.

In some non-limiting embodiments or aspects, the one or more instructions that cause the processor(s) to transfer the selected amount of the cryptocurrency from the smart contract to the seller account cause the processor(s) to execute the smart contract within the first blockchain network associated with the cryptocurrency.

In some non-limiting embodiments or aspects, the smart contract may be associated with a target time period, the target time period may include a duration of time from a first time that the smart contract may be generated to a second time that the smart contract may be executed.

In some non-limiting embodiments or aspects, the non-retrievable address may include an address on a second blockchain network.

In some non-limiting embodiments or aspects, the non-retrievable address may include a public address associated with the first blockchain network. Generating the non-retrievable address may include generating the public address and a private key associated with the public address and/or discarding the private key.

Other non-limiting embodiments or aspects will be set forth in the following numbered clauses:
Clause 1: A computer-implemented method, comprising: receiving, with at least one processor, a first instruction to exchange a selected amount of a cryptocurrency from a buyer account for a digital asset from a seller account; transmitting, with at least one processor, a second instruction to transfer the digital asset from the seller account; transmitting, with at least one processor, a third instruction to transfer the selected amount of the cryptocurrency from the buyer account; generating, with at least one processor, a smart contract within a first blockchain network associated with the cryptocurrency based on the second instruction to transfer the digital asset and the third instruction to transfer the selected amount of cryptocurrency; transferring, with at least one processor, the selected amount of the cryptocurrency from the buyer account and the digital asset from the seller account to the smart contract; transferring, with at least one processor, the selected amount of the cryptocurrency from the smart contract to the seller account; generating, with at least one processor, a non-retrievable address; and transferring, with at least one processor, the digital asset from the smart contract to the non-retrievable address.
Clause 2: The computer-implemented method of clause 1, further comprising: generating, with at least one processor, a confirmation message indicating that the digital asset was transferred to the non-retrievable address; and transmitting, with at least one processor, the confirmation message to the buyer account.
Clause 3: The computer-implement method of clause 1 or clause 2, wherein transferring the selected amount of the cryptocurrency from the smart contract to the seller account comprises: determining that the smart contract has a sufficient amount of the cryptocurrency to transfer to the seller account; and transferring a portion of the selected amount of the cryptocurrency from the smart contract to the seller at each recurring period of a plurality of recurring periods within a duration.
Clause 4: The computer-implemented method of any of clauses 1-3, wherein transferring the selected amount of the cryptocurrency from the smart contract to the seller account comprises executing the smart contract within the first blockchain network associated with the cryptocurrency.
Clause 5: The computer-implemented method of any of clauses 1-4, wherein the smart contract is associated with a target time period, the target time period comprising a duration of time from a first time that the smart contract is generated to a second time that the smart contract is executed.
Clause 6: The computer-implemented method of any of clauses 1-5, wherein the non-retrievable address comprises an address on a second blockchain network.
Clause 7: The computer-implemented method of any of clauses 1-6, wherein the non-retrievable address comprises a public address associated with the first blockchain network, wherein generating the non-retrievable address comprises: generating the public address and a private key associated with the public address; and discarding the private key.
Clause 8: A system comprising at least one processor programmed or configured to: receive a first instruction to exchange a selected amount of a cryptocurrency from a buyer account for a digital asset from a seller account; transmit a second instruction to transfer the digital asset from the seller account; transmit a third instruction to transfer the selected amount of the cryptocurrency from the buyer account; generate a smart contract within a first blockchain network associated with the cryptocurrency based on the second instruction to transfer the digital asset and the third instruction to transfer the selected amount of cryptocurrency; transfer the selected amount of the cryptocurrency from the buyer account and the digital asset from the seller account to the smart contract; transfer the selected amount of the cryptocurrency from the smart contract to the seller account; generate a non-retrievable address; and transfer the digital asset from the smart contract to the non-retrievable address.
Clause 9: The system of clause 8, wherein the at least one processor is further programmed or configured to: generate a confirmation message indicating that the digital asset was transferred to the non-retrievable address; and transmit the confirmation message to the buyer account.
Clause 10: The system of clause 8 or clause 9, wherein, when transferring the selected amount of the cryptocurrency from the smart contract to the seller account, the at least one processor is programmed or configured to: determine that the smart contract has a sufficient amount of the cryptocurrency to transfer to the seller account; and transfer a portion of the selected amount of the cryptocurrency from the smart contract to the seller at each recurring period of a plurality of recurring periods within a duration.
Clause 11: The system of any of clauses 8-10, wherein, when transferring the selected amount of the cryptocurrency from the smart contract to the seller account, the at least one processor is programmed or configured to execute the smart contract within the first blockchain network associated with the cryptocurrency.
Clause 12: The system of any of clauses 8-11, wherein the smart contract is associated with a target time period, the target time period comprising a duration of time from a first time that the smart contract is generated to a second time that the smart contract is executed.
Clause 13: The system of any of clauses 8-12, wherein the non-retrievable address comprises an address on a second blockchain network.
Clause 14: The system of any of clauses 8-13, wherein the non-retrievable address comprises a public address associated with the first blockchain network, wherein, when generating the non-retrievable address, the at least one processor is programmed or configured to: generate the public address and a private key associated with the public address; and discard the private key.
Clause 15: A computer program product comprising at least one non-transitory computer readable medium including one or more instructions that, when executed by at least one processor, cause the at least one processor to: receive a first instruction to exchange a selected amount of a cryptocurrency from a buyer account for a digital asset from a seller account; transmit a second instruction to transfer the digital asset from the seller account; transmit a third instruction to transfer the selected amount of the cryptocurrency from the buyer account; generate a smart contract within afirst blockchain network associated with the cryptocurrency based on the second instruction to transfer the digital asset and the third instruction to transfer the selected amount of cryptocurrency; transfer the selected amount of the cryptocurrency from the buyer account and the digital asset from the seller account to the smart contract; transfer the selected amount of the cryptocurrency from the smart contract to the seller account; generate a non-retrievable address; and transfer the digital asset from the smart contract to the non-retrievable address.
Clause 16: The computer program product of clause 15, wherein the one or more instructions that cause the at least one processor to transfer the selected amount of the cryptocurrency from the smart contract to the seller account cause the at least one processor to: determine that the smart contract has a sufficient amount of the cryptocurrency to transfer to the seller account; and transfer a portion of the selected amount of the cryptocurrency from the smart contract to the seller at each recurring period of a plurality of recurring periods within a duration.
Clause 17: The computer program product of clause 15 or clause 16, wherein the one or more instructions that cause the at least one processor to transfer the selected amount of the cryptocurrency from the smart contract to the seller account cause the at least one processor to execute the smart contract within the first blockchain network associated with the cryptocurrency.
Clause 18: The computer program product of any of clause 15-17, wherein the smart contract is associated with a target time period, the target time period comprising a duration of time from a first time that the smart contract is generated to a second time that the smart contract is executed.
Clause 19: The computer program product of any of clause 15-18, wherein the non-retrievable address comprises an address on a second blockchain network.
Clause 20: The computer program product of any of clause 15-19, wherein the non-retrievable address comprises a public address associated with the first blockchain network, wherein generating the non-retrievable address comprises: generating the public address and a private key associated with the public address; and discarding the private key.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the present disclosure are explained in greater detail below with reference to the exemplary embodiments or aspects that are illustrated in the accompanying schematic figures, in which:

FIG. 1 is a diagram of an example environment in which systems, devices, products, apparatuses, and/or methods, described herein, may be implemented, according to some non-limiting embodiments or aspects of the present disclosure;

FIG. 2 is a diagram of example components of one or more devices of FIG. 1, according to some non-limiting embodiments or aspects of the present disclosure;

FIG. 3 is a flowchart of an example process for generating a single-use digital asset, according to some non-limiting embodiments or aspects of the present disclosure;

FIG. 4 is a diagram of an example implementation of a process for generating a single-use digital asset, according to some non-limiting embodiments or aspects of the present disclosure; and

FIG. 5 is a diagram of an example implementation of a process for generating a single-use digital asset, according to some non-limiting embodiments or aspects of the present disclosure.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments or aspects disclosed herein are not to be considered as limiting unless otherwise indicated.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. The phrase “based on” may also mean “in response to” where appropriate.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments or aspects, a message may refer to a network packet (e.g., a data packet and/or the like) that includes data.

As used herein, the terms “issuer,” “issuer institution,” “issuer bank,” or “payment device issuer,” may refer to one or more entities that provide accounts to individuals (e.g., users, customers, and/or the like) for conducting payment transactions, such as credit payment transactions and/or debit payment transactions. For example, an issuer institution may provide an account identifier, such as a primary account number (PAN), to a customer that uniquely identifies one or more accounts associated with that customer. In some non-limiting embodiments or aspects, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa®, MasterCard®, American Express®, or any other entity that processes transactions. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments or aspects, may be operated by or on behalf of a transaction service provider.

As used herein, the term “merchant” may refer to one or more entities (e.g., operators of retail businesses) that provide goods and/or services, and/or access to goods and/or services, to a user (e.g., a customer, a consumer, and/or the like) based on a transaction, such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “acquirer” may refer to an entity licensed by the transaction service provider and approved by the transaction service provider to originate transactions (e.g., payment transactions) involving a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions involving a payment device associated with the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting embodiments or aspects, an acquirer may be a financial institution, such as a bank.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

As used herein, the terms “client” and “client device” may refer to one or more computing devices, such as processors, storage devices, and/or similar computer components, that access a service made available by a server. In some non-limiting embodiments or aspects, a client device may include a computing device configured to communicate with one or more networks and/or facilitate transactions such as, but not limited to, one or more desktop computers, one or more portable computers (e.g., tablet computers), one or more mobile devices (e.g., cellular phones, smartphones, personal digital assistant, wearable devices, such as watches, glasses, lenses, and/or clothing, and/or the like), and/or other like devices. Moreover, the term “client” may also refer to an entity that owns, utilizes, and/or operates a client device for facilitating transactions with another entity.

As used herein, the term “server” may refer to one or more computing devices, such as processors, storage devices, and/or similar computer components that communicate with client devices and/or other computing devices over a network, such as the Internet or private networks and, in some examples, facilitate communication among other servers and/or client devices.

As used herein, the term “system” may refer to one or more computing devices or combinations of computing devices such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments or aspects of the present disclosure are directed to methods, systems, and computer program products for facilitating digital assets, including, but not limited to, generating a single-use digital asset. For example, non-limiting embodiments or aspects of the present disclosure provide receiving a first instruction to exchange a selected amount of a cryptocurrency from a buyer account for a digital asset from a seller account, transmitting a second instruction to transfer the digital asset from the seller account and a third instruction to transfer the selected amount of the cryptocurrency from the buyer account, generating a smart contract within a first blockchain network associated with the cryptocurrency based on the second instruction to transfer the digital asset and the third instruction to transfer the selected amount of cryptocurrency, transferring the selected amount of the cryptocurrency from the buyer account and the digital asset from the seller account to the smart contract, transferring the selected amount of the cryptocurrency from the smart contract to the seller account, generating a non-retrievable address, and transferring the digital asset from the smart contract to the non-retrievable address. Such embodiments or aspects provide techniques and systems that enable retirement of the digital asset upon (e.g., immediately upon) completion of an exchange involving the digital asset (e.g., exchange of the cryptocurrency for the digital asset). As such, the digital asset cannot be reused and/or transferred to another party (e.g., a subsequent purchaser). For example, even though the digital asset continues to exist, the digital asset may be unusable because the non-retrievable address prevents proving ownership of the digital asset and/or transferring the digital asset from the non-retrievable address to another address. In this way, a persistently existing digital asset may be ensured to be limited to a single use (e.g., single exchange). Additionally or alternatively, non-limiting embodiments or aspects of the present disclosure provide transferring a portion of the selected amount of the cryptocurrency from the smart contract to the seller at each recurring period of a plurality of recurring periods within a duration. As such, multiple transfers of cryptocurrency (e.g., installment payments) may occur over time for a single digital asset. For example, multiple transfers of cryptocurrency may be initiated automatically (e.g., pull payments) for a single digital asset (e.g., the asset may be used a single time in exchange for the entire series of periodic payments).

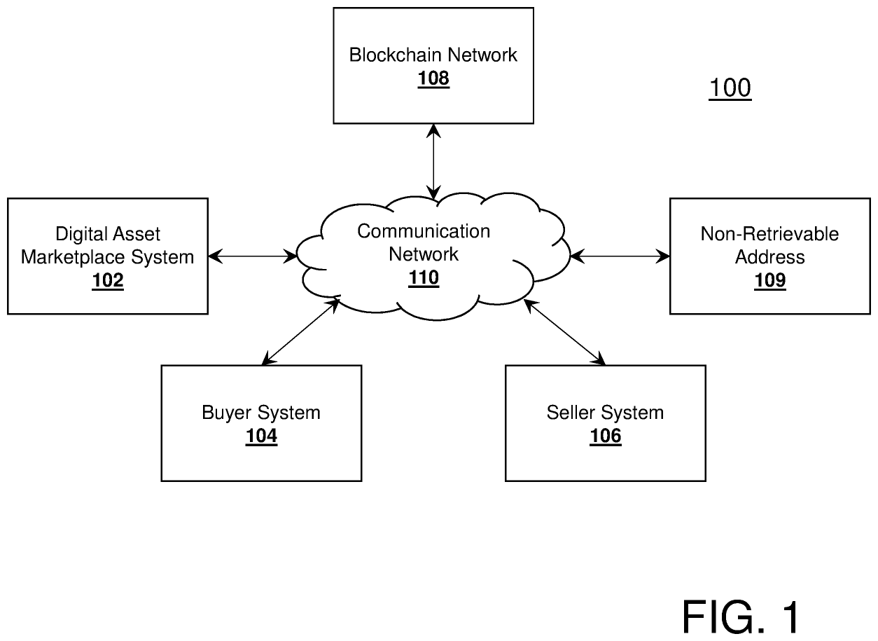

Referring now to FIG. 1, FIG. 1 is a diagram of an example environment 100 in which methods, systems, and/or computer program products, described herein, may be implemented, according to some non-limiting embodiments or aspects. As shown in FIG. 1, environment 100 may include digital asset marketplace system 102, buyer system 104, seller system 106, blockchain network 108, and/or non-retrievable address 109.

Digital asset marketplace system 102 may include one or more devices capable of receiving information from and/or communicating information to buyer system 104, seller system 106, blockchain network 108, and/or non-retrievable address 109 (e.g., via communication network 110 and/or the like). For example, digital asset marketplace system 102 may include at least one computing device, such as a server, a group of servers, and/or other like devices. In some non-limiting embodiments or aspects, digital asset marketplace system 102 may be in communication with a data storage device, which may be local or remote to digital asset marketplace system 102. In some non-limiting embodiments or aspects, digital asset marketplace system 102 may be capable of receiving information from, storing information in, communicating information to, or searching information stored in the data storage device. In some non-limiting embodiments or aspects, digital asset marketplace system 102 may store and/or receive one or more listings for digital assets. For example, each listing may include and/or be associated with an offer (e.g., from seller system 106 and/or from an account of a prospective seller) to exchange a digital asset for a selected amount of cryptocurrency and/or the like. In some non-limiting embodiments or aspects, digital asset marketplace system 102 may host a digital asset marketplace including the listings for digital assets.

Buyer system 104 may include one or more devices capable of receiving information from and/or communicating information to digital asset marketplace system 102, seller system 106, blockchain network 108, and/or non-retrievable address 109 (e.g., via communication network 110 and/or the like). For example, buyer system 104 may include at least one computing device, such as a client device, a desktop computer, a portable computer, a mobile device, a server, a group of servers, and/or other like devices. In some non-limiting embodiments or aspects, buyer system 104 may include and/or be associated with an account of a buyer (e.g., a buyer account), such as a digital wallet of the buyer. For example, the buyer account may include and/or be associated with at least one amount of at least one type of cryptocurrency.

Seller system 106 may include one or more devices capable of receiving information from and/or communicating information to digital asset marketplace system 102, buyer system 104, blockchain network 108, and/or non-retrievable address 109 (e.g., via communication network 110 and/or the like). For example, seller system 106 may include at least one computing device, such as a client device, a desktop computer, a portable computer, a mobile device, a server, a group of servers, and/or other like devices. In some non-limiting embodiments or aspects, seller system 106 may include and/or be associated with an account of a seller (e.g., a seller account), such as a digital wallet of the seller. For example, the buyer account may include and/or be associated with at least one digital asset.

Blockchain network 108 may include a blockchain network, as described herein. For example, blockchain network 108 may include a plurality of devices capable of receiving information from and/or communicating information to digital asset marketplace system 102, buyer system 104, seller system 106, and/or non-retrievable address 109 (e.g., via communication network 110 and/or the like). For example, blockchain network 108 may include a computer network of distributed computing devices, such as client devices, servers, a group of servers, and/or other like devices. In some non-limiting embodiments or aspects, at least some of the computing devices of blockchain network 108 may serve as one or more ledgers (e.g., a distributed ledger). In some non-limiting embodiments or aspects, blockchain network 108 may document transactions by generating blocks including data associated with the transactions (e.g., data associated with each transaction may be stored in a block within the blockchain). For example, blockchain network 108 may include at least one blockchain including one or more blocks, and each block may include (e.g., record) data associated with at least one transaction (e.g., data associated with a unique transaction). For example, a block may include one or more cryptographic hashes, a timestamp, an amount of digital currency and/or a digital asset, and/or the like. Additionally or alternatively, blockchain network 108 may execute transactions using smart contracts (e.g., software instructions that may execute transactions), as described herein. In some non-limiting embodiments or aspects, at least one of digital asset marketplace system 102, buyer system 104, and/or seller system 106 may be (and/or may include at least one computing device that is) part of blockchain network 108.

Non-retrievable address 109 may include an address on a blockchain network (e.g., blockchain network 108 and/or another blockchain network) from which a digital asset cannot be retrieved upon transfer of the digital asset to non-retrievable address 109. For example, non-retrievable address 109 may include a public address associated with blockchain network 108, and the private key associated with the public address may be discarded, as described herein. Additionally or alternatively, non-retrievable address 109 may include an address on another blockchain network (e.g., a second blockchain network) separate from blockchain network 108 (e.g., a first blockchain network used to facilitate the exchange of the digital asset from the seller account for the cryptocurrency from the buyer account).

Communication network 310 may include one or more wired and/or wireless networks. For example, communication network 310 may include a cellular network (e.g., a long-term evolution (LTE) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

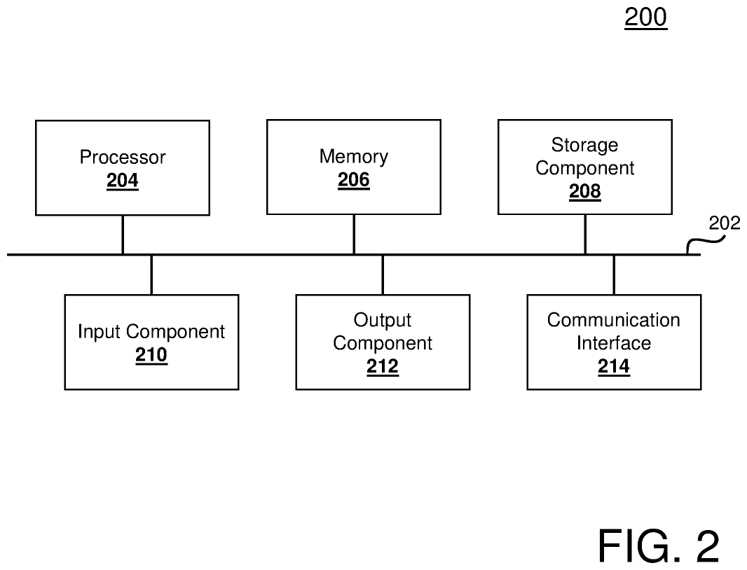

Referring now to FIG. 2, FIG. 2 is a diagram of example components of a device 200, according to some non-limiting embodiments or aspects of the present disclosure. Device 200 may correspond to digital asset marketplace system 102, buyer system 104, seller system 106, and/or blockchain network 108. In some non-limiting embodiments or aspects, digital asset marketplace system 102, buyer system 104, seller system 106, and/or blockchain network 108 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage memory (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

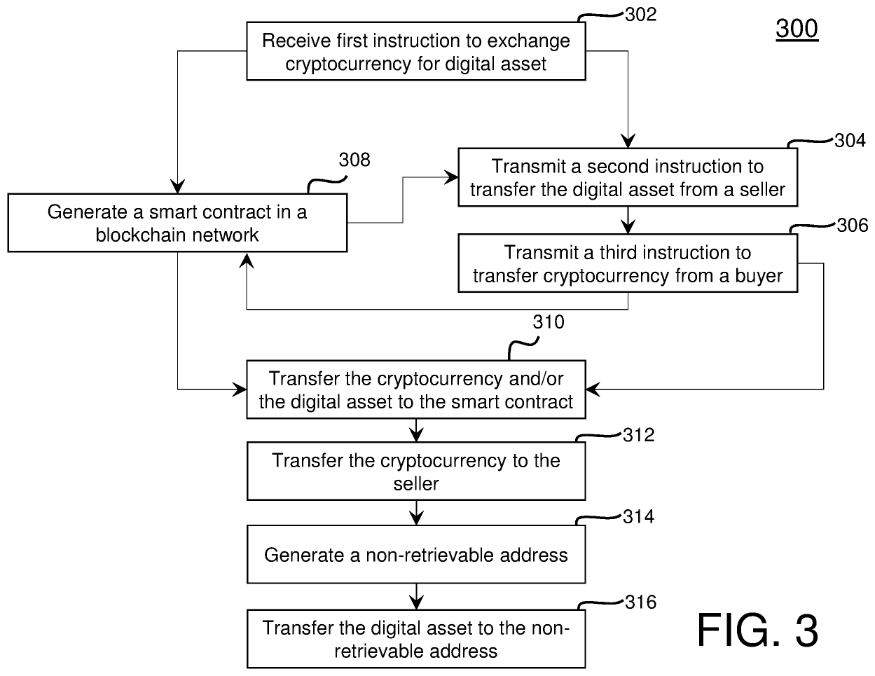

Referring now to FIG. 3, FIG. 3 is a flowchart of a process 300 for generating a single-use digital asset, according to some non-limiting embodiments or aspects of the present disclosure. In some non-limiting embodiments or aspects, one or more of the steps of process 300 may be performed (e.g., completely, partially, etc.) by digital asset marketplace system 102. In some non-limiting embodiments or aspects, one or more of the steps of process 300 may be performed (e.g., completely, partially, etc.) by another device or a group of devices separate from or including digital asset marketplace system 102, such as buyer system 104, seller system 106, blockchain network 108, and/or non-retrievable address 109. The steps shown in FIG. 3 are for example purposes only. It will be appreciated that additional, fewer, different, and/or a different order of steps may be used in non-limiting embodiments or aspects.

As shown in FIG. 3, at step 302, process 300 may include receiving a first instruction to exchange cryptocurrency for a digital asset. For example, digital asset marketplace system 102 may receive a first instruction (e.g., from buyer system 104 and/or a buyer account associated therewith) to exchange a selected amount of a cryptocurrency from a buyer account for a digital asset from a seller account.

In some non-limiting embodiments or aspects, the first instruction may be based on buyer system 104 receiving input (e.g., from a user) associated with initiating an exchange based on a listing for the digital asset. For example, digital asset marketplace system 102 may receive and store at least one listing for at least one digital asset (e.g., a plurality of listings for a plurality of digital assets) from at least one seller system 106 (e.g., a plurality of seller systems 106). Digital asset marketplace system 102 may host the listing(s) in a manner accessible to at least one buyer system 104 (e.g., a plurality of buyer systems 104). For example, digital asset marketplace system 102 may communicate the listing(s) to buyer system 104 upon receiving a request from the buyer system. Additionally or alternatively, digital asset marketplace system 102 may communicate a graphical user interface including listing data associated with the listing(s) to buyer system 104. In some non-limiting embodiments or aspects, each listing may include and/or be associated with an offer (e.g., from seller system 106 and/or from an account of a prospective seller) to exchange a digital asset for a selected amount of cryptocurrency and/or the like. Buyer system 104 may select at least one of the listing(s) (e.g., based on input from a user and/or the like) to initiate an exchange.

As shown in FIG. 3, at step 304, process 300 may include transmitting a second instruction to transfer the digital asset from a seller. For example, digital asset marketplace system 102 may transmit a second instruction (e.g., to seller system 106 and/or a seller account associated therewith) to transfer the digital asset from the seller account.

As shown in FIG. 3, at step 306, process 300 may include transmitting a third instruction to transfer cryptocurrency from a buyer. For example, digital asset marketplace system 102 may transmit a third instruction (e.g., to buyer system 104 and/or a buyer account associated therewith) to transfer the selected amount of the cryptocurrency from the buyer account.

As shown in FIG. 3, at step 308, process 300 may include generating a smart contract in a blockchain network. For example, digital asset marketplace system 102 may generate a smart contract within blockchain network 108 (e.g., a blockchain network associated with the cryptocurrency).

In some non-limiting embodiments or aspects, step 308 may occur after (e.g., in response to and/or based on) steps 304 and 306. For example, digital asset marketplace system 102 may generate the smart contract within blockchain network 108 based on the second instruction to transfer the digital asset and the third instruction to transfer the selected amount of cryptocurrency.

In some non-limiting embodiments or aspects, step 308 may occur before steps 304 and 306 (e.g., steps 304 and 306 may be in response to and/or based on step 308). For example, digital asset marketplace system 102 may generate the smart contract within blockchain network 108 to receive the digital asset from the seller account and the selected amount of the cryptocurrency from the buyer account. In response to generating the smart contract, digital asset marketplace system 102 may transmit the second instruction to transfer the digital asset from the seller account to the smart contract and the third instruction to transfer the selected amount of the cryptocurrency from the buyer account to the smart contract.

As shown in FIG. 3, at step 310, process 300 may include transferring the cryptocurrency and/or the digital asset to the smart contract. For example, digital asset marketplace system 102 may transfer the selected amount of the cryptocurrency from the buyer account (e.g., associated with buyer system 104) and the digital asset from the seller account (e.g., associated with seller system 106) to the smart contract.

In some non-limiting embodiments or aspects, transferring the selected amount of the cryptocurrency to the smart contract may include transferring a portion of the selected amount of the cryptocurrency from the buyer account to the smart contract at each recurring period of a plurality of recurring periods within a duration.

As shown in FIG. 3, at step 312, process 300 may include transferring the cryptocurrency to the seller. For example, digital asset marketplace system 102 and/or the smart contract (e.g., within blockchain network 108) may transfer the selected amount of the cryptocurrency from the smart contract to the seller account (e.g., associated with seller system 106).

In some non-limiting embodiments or aspects, transferring the selected amount of the cryptocurrency from the smart contract to the seller account may include executing the smart contract within blockchain network 108. For example, the smart contract may be associated with a target time period (e.g., a duration of time from a first time that the smart contract is generated to a second time that the smart contract is to be executed). Blockchain network 108 may execute the smart contract based on the target time period (e.g., at the end of the duration of time).

In some non-limiting embodiments or aspects, transferring the selected amount of the cryptocurrency from the smart contract to the seller account may include determining (e.g., by blockchain network 108 and/or digital asset marketplace system 102) that the smart contract has a sufficient amount of the cryptocurrency to transfer to the seller account. Additionally or alternatively, the smart contract (e.g., being executed by blockchain network 108) may transfer a portion of the selected amount of the cryptocurrency to the seller at each recurring period of a plurality of recurring periods within a duration.

As shown in FIG. 3, at step 314, process 300 may include generating a non-retrievable address. For example, digital asset marketplace system 102 and/or the smart contract (e.g., within blockchain network 108) may generate non-retrievable address 109.

In some non-limiting embodiments or aspects, non-retrievable address 109 may include an address on a second blockchain network (e.g., separate from blockchain network 108). For example, digital asset marketplace system 102 may generate the address on the second blockchain network.

In some non-limiting embodiments or aspects, non-retrievable address 109 may include a public address associated with blockchain network 108. For example, digital asset marketplace system 102 and/or blockchain network 108 may generate the public address and a private key associated with the public address, the private key may be discarded. For example, digital asset marketplace system 102 may receive the private key and automatically delete the private key. Additionally or alternatively, digital asset marketplace system 102 may reject and/or prevent reception of the private key. Additionally or alternatively, blockchain network 108 may prevent transmission of the private key. In some non-limiting embodiments or aspects, without the private key, any digital assets transferred to the public address may be irretrievable (e.g., unusable for future transactions). For example, the digital asset may be unusable because, without the private key, no entity may be able to prove ownership of the digital asset associated with the public address.

As shown in FIG. 3, at step 316, process 300 may include transferring the digital asset to the non-retrievable address. For example, digital asset marketplace system 102 and/or the smart contract (e.g., within blockchain network 108) may transfer the digital asset from the smart contract to non-retrievable address 109.

In some non-limiting embodiments or aspects, digital asset marketplace system 102 and/or the smart contract (e.g., within blockchain network 108) may generate a confirmation message indicating that the digital asset was transferred to non-retrievable address 109. Additionally or alternatively, digital asset marketplace system 102 and/or the smart contract (e.g., within blockchain network 108) may transmit the confirmation message to the buyer account.

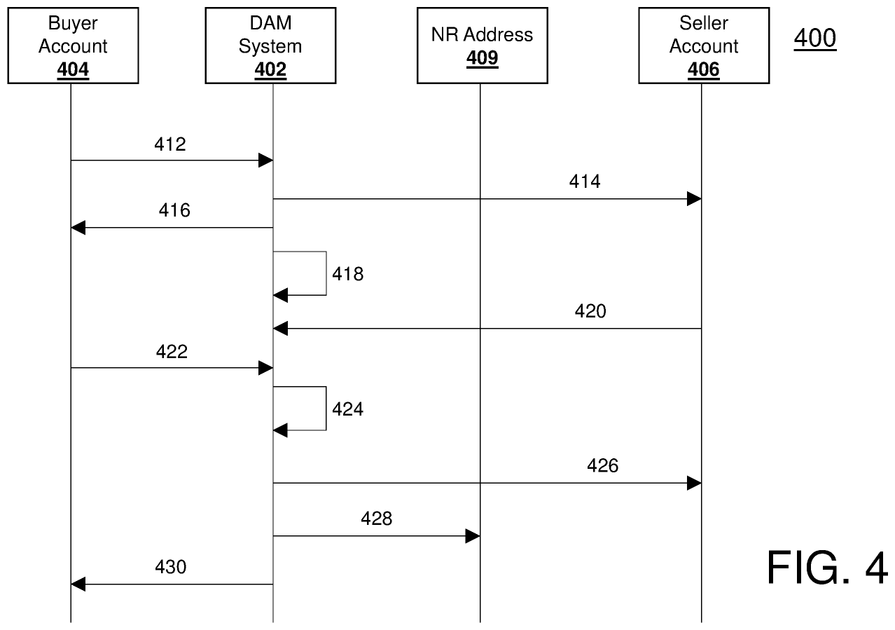

Referring now to FIG. 4, FIG. 4 is a swimlane diagram of an implementation 400 of a process (e.g., process 300) for generating a single-use digital asset, according to some non-limiting embodiments or aspects of the present disclosure. The steps shown in FIG. 4 are for example purposes only. It will be appreciated that additional, fewer, different, and/or a different order of steps may be used in non-limiting embodiments or aspects. In some non-limiting embodiments or aspects, digital asset marketplace (DAM) system 402 may be the same as or similar to digital asset marketplace system 102. In some non-limiting embodiments or aspects, buyer account 404 may be the same as, similar to, and/or associated with buyer system 104. In some non-limiting embodiments or aspects, seller account 406 may be the same as, similar to, and/or associated with seller system 106. In some non-limiting embodiments or aspects, non-retrievable (NR) address 409 may be the same as or similar to non-retrievable address 109.

As shown in FIG. 4, at step 412, implementation 400 may include receiving a first instruction to exchange cryptocurrency for a digital asset, as described herein. For example, buyer account 404 may transmit and/or digital asset marketplace system 402 may receive a first instruction to exchange a selected amount of a cryptocurrency from a buyer account 404 for a digital asset from a seller account 406.

In some non-limiting embodiments or aspects, the cryptocurrency may include a stabelcoin. For example, the cryptocurrency may include a United Stated Dollar Coin (USDC), which may be a digital stablecoin pegged to the United States dollar.

In some non-limiting embodiments or aspects, the digital asset may include and/or be associated with a single-use asset. For example, the digital asset may be associated with a carbon credit, an insurance policy (e.g., for one term, such as a 1-year policy, a 6-month policy, and/or the like), a unit of energy, and/or the like.

In some non-limiting embodiments or aspects, the first instruction may be communicated by at least one application programming interface (API). For example, digital asset marketplace system 402 may provide (e.g., communicate, make available, and/or the like) the API to buyer account 404 and/or a buyer system associated therewith.

In some non-limiting embodiments or aspects, the purchase amount listed in the digital asset marketplace (e.g., of digital asset marketplace system 402) may be in a fiat currency (e.g., United Stated dollars, euros, pounds, and/or the like). For example, the first instruction may include a selected amount of fiat currency, and digital asset marketplace system 402 may convert the selected amount of fiat currency to the selected amount of cryptocurrency. In some non-limiting embodiments or aspects, the conversion from fiat currency to cryptocurrency may be communicated by at least one API.

As shown in FIG. 4, at step 414, implementation 400 may include transmitting a second instruction to transfer the digital asset from a seller account 406, as described herein. For example, digital asset marketplace system 402 may transmit and/or seller account 406 may receive a second instruction to transfer the digital asset from the seller account 406.

In some non-limiting embodiments or aspects, the second instruction may direct seller account 406 to deliver the digital asset from seller account 406 (e.g., a digital wallet associated with the seller) to the smart contract.

In some non-limiting embodiments or aspects, the second instruction may be communicated by at least one API. For example, digital asset marketplace system 402 may provide (e.g., communicate, make available, and/or the like) the API to seller account 406 and/or a seller system associated therewith.

As shown in FIG. 4, at step 416, implementation 400 may include transmitting a third instruction to transfer cryptocurrency from a buyer account 404, as described herein. For example, digital asset marketplace system 402 may transmit and/or buyer account 404 may receive a third instruction to transfer the selected amount of the cryptocurrency from the buyer account 404.

In some non-limiting embodiments or aspects, the third instruction may direct buyer account 404 (e.g., a digital wallet associated with the buyer) to transfer the cryptocurrency to the smart contract.

In some non-limiting embodiments or aspects, the third instruction may be communicated by at least one API. For example, digital asset marketplace system 402 may provide (e.g., communicate, make available, and/or the like) the API to buyer account 404 and/or a buyer system associated therewith.

As shown in FIG. 4, at step 418, implementation 400 may include generating a smart contract in a blockchain network. For example, digital asset marketplace system 402 may generate a smart contract within a blockchain network 108.

In some non-limiting embodiments or aspects, step 418 may occur after (e.g., in response to and/or based on) steps 414 and 416, as described herein. In some non-limiting embodiments or aspects, step 418 may occur before steps 414 and 416 (e.g., steps 414 and 416 may be in response to and/or based on step 418), as described herein.

In some non-limiting embodiments or aspects, the smart contract may determine (and/or receive evidence from buyer account 404) that sufficient funds are available from buyer account 404 to purchase the digital asset. Additionally or alternatively, the smart contract may determine (and/or receive evidence from seller account 406) that the digital asset is available to transfer.

In some non-limiting embodiments or aspects, the smart contract may be generated by at least one API. For example, digital asset marketplace system 402 may use (e.g., include, have access to, and/or the like) the API to generate the smart contract in the blockchain network 108.

As shown in FIG. 4, at step 420, implementation 400 may include transferring the digital asset to the smart contract, as described herein. For example, digital asset marketplace system 402 may transfer the digital asset from seller account 406 to the smart contract.

In some non-limiting embodiments or aspects, the digital asset may be transferred by at least one API. For example, digital asset marketplace system 402 may use (e.g., include, have access to, and/or the like) the API to transfer the digital asset.

As shown in FIG. 4, at step 422, implementation 400 may include transferring the cryptocurrency to the smart contract, as described herein. For example, digital asset marketplace system 402 may transfer the selected amount of the cryptocurrency from buyer account 404 to the smart contract.

In some non-limiting embodiments or aspects, the cryptocurrency may be transferred by at least one API. For example, digital asset marketplace system 402 may use (e.g., include, have access to, and/or the like) the API to transfer the currency.

In some non-limiting embodiments or aspects, transferring the cryptocurrency may include debiting an amount of fiat currency from another account (e.g., a bank account, a payment account, a credit account, and/or the like) of the buyer. Additionally or alternatively, the fiat currency may be exchanged for the cryptocurrency. For example, digital asset marketplace system 402 may debit the fiat currency from the other account and/or exchange the fiat currency for the cryptocurrency by at least one API. In some non-limiting embodiments or aspects, after exchanging the fiat currency for the cryptocurrency, digital asset marketplace system 402 may transfer the cryptocurrency from buyer account 404 to the smart contract.

As shown in FIG. 4, at step 424, implementation 400 may include generating a non-retrievable address, as described herein. For example, digital asset marketplace system 402 and/or the smart contract may generate non-retrievable address 409.

In some non-limiting embodiments or aspects, the non-retrievable address 409 may be generated by at least one API. For example, digital asset marketplace system 402 may use (e.g., include, have access to, and/or the like) the API to generate the non-retrievable address 409.

As shown in FIG. 4, at step 426, implementation 400 may include transferring the cryptocurrency to the seller account, as described herein. For example, digital asset marketplace system 402 and/or the smart contract may transfer the selected amount of the cryptocurrency from the smart contract to seller account 406.

In some non-limiting embodiments or aspects, the cryptocurrency may be transferred by at least one API. For example, digital asset marketplace system 402 may use (e.g., include, have access to, and/or the like) the API to transfer the currency.

In some non-limiting embodiments or aspects, transferring the cryptocurrency may include exchanging the cryptocurrency for the fiat currency (e.g., a selected fiat currency of the seller, a fiat currency of another account of the seller, and/or the like). Additionally or alternatively, the fiat currency may be credited to another account (e.g., a bank account, a payment account, a credit account, and/or the like) of the seller. For example, digital asset marketplace system 402 may exchange the cryptocurrency for the fiat currency and/or credit the fiat currency to the other account by at least one API.

As shown in FIG. 4, at step 428, implementation 400 may include transferring the digital asset to the non-retrievable address, as described herein. For example, digital asset marketplace system 402 and/or the smart contract may transfer the digital asset from the smart contract to non-retrievable address 409.

In some non-limiting embodiments or aspects, the digital asset may be transferred by at least one API. For example, digital asset marketplace system 402 may use (e.g., include, have access to, and/or the like) the API to transfer the digital asset.

As shown in FIG. 4, at step 430, implementation 400 may include transmitting a confirmation message to the buyer account, as described herein. For example, digital asset marketplace system 402 and/or the smart contract may generate a confirmation message indicating that the digital asset was transferred to non-retrievable address 409. Additionally or alternatively, digital asset marketplace system 402 and/or the smart contract (e.g., within blockchain network 108) may transmit the confirmation message to buyer account 404.

In some non-limiting embodiments or aspects, the confirmation message may be transmitted by at least one API. For example, digital asset marketplace system 402 may use (e.g., include, have access to, and/or the like) the API to transmit the confirmation message.

In some non-limiting embodiments or aspects, at least one of (e.g., all of) steps 420-430 may occur based on the smart contract executing, as described herein. For example, the smart contract may execute based on determining that the cryptocurrency and the digital asset are available for transfer, as described herein. Additionally or alternatively, the smart contract may execute based on a target time period, as described herein.

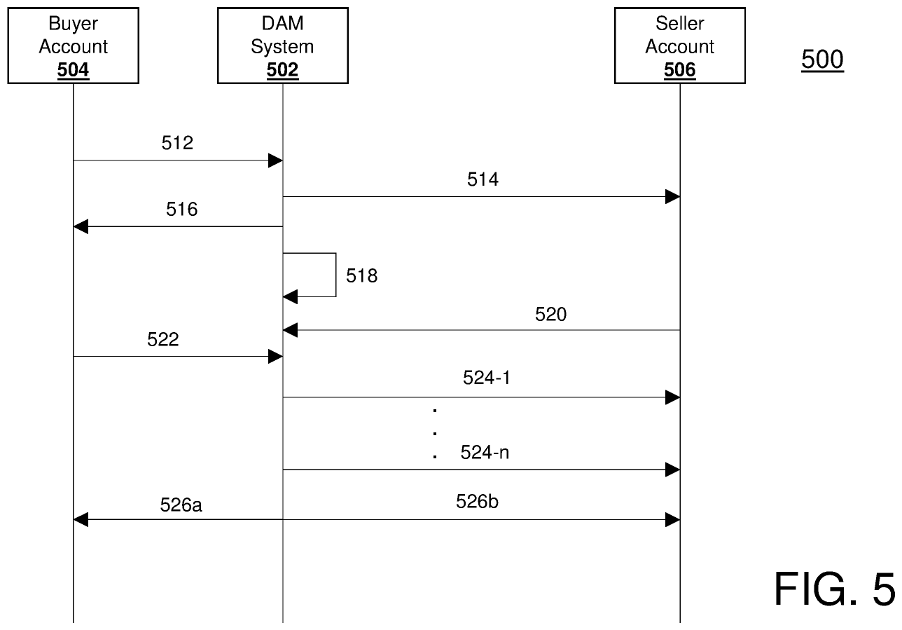

Referring now to FIG. 5, FIG. 5 is a swimlane diagram of an implementation 500 of a process (e.g., process 300) for generating a single-use digital asset, according to some non-limiting embodiments or aspects of the present disclosure. The steps shown in FIG. 5 are for example purposes only. It will be appreciated that additional, fewer, different, and/or a different order of steps may be used in non-limiting embodiments or aspects. In some non-limiting embodiments or aspects, digital asset marketplace (DAM) system 502 may be the same as or similar to digital asset marketplace system 102 and/or digital asset marketplace system 402. In some non-limiting embodiments or aspects, buyer account 504 may be the same as, similar to, and/or associated with buyer system 104 and/or buyer account 404. In some non-limiting embodiments or aspects, seller account 506 may be the same as, similar to, and/or associated with seller system 106 and/or seller account 406.

As shown in FIG. 5, at step 512, implementation 500 may include receiving a first instruction to exchange cryptocurrency for a digital asset, as described herein. For example, buyer account 504 may transmit and/or digital asset marketplace system 502 may receive a first instruction to exchange a selected amount of a cryptocurrency from a buyer account 504 for a digital asset from a seller account 506.

In some non-limiting embodiments or aspects, the cryptocurrency may include a stabelcoin. For example, the cryptocurrency may include a United Stated Dollar Coin (USDC), which may be a digital stablecoin pegged to the United States dollar.

In some non-limiting embodiments or aspects, the digital asset may include and/or be associated with a single-use asset. For example, the digital asset may be associated with a carbon credit, an insurance policy (e.g., for one term, such as a 1-year policy, a 6-month policy, and/or the like), a unit of energy, and/or the like.

In some non-limiting embodiments or aspects, the first instruction may be communicated by at least one API. For example, digital asset marketplace system 502 may provide (e.g., communicate, make available, and/or the like) the API to buyer account 504 and/or a buyer system associated therewith.

In some non-limiting embodiments or aspects, the first instruction may include an indication to transfer portions of the selected amount of a cryptocurrency periodically (e.g., installment payments and/or the like). For example, the indication may indicate a portion of the selected amount of the cryptocurrency to be transferred at each recurring period of a plurality of recurring periods within a duration.

As shown in FIG. 5, at step 514, implementation 500 may include transmitting a second instruction to transfer the digital asset from a seller account, as described herein. For example, digital asset marketplace system 502 may transmit and/or seller account 506 may receive a second instruction to transfer the digital asset from the seller account 506.

In some non-limiting embodiments or aspects, the second instruction may direct seller account 506 to deliver the digital asset from seller account 506 (e.g., a digital wallet associated with the seller) to the smart contract.

In some non-limiting embodiments or aspects, the second instruction may be communicated by at least one API. For example, digital asset marketplace system 502 may provide (e.g., communicate, make available, and/or the like) the API to seller account 506 and/or a seller system associated therewith.

As shown in FIG. 5, at step 516, implementation 500 may include transmitting a third instruction to transfer cryptocurrency from a buyer account, as described herein.

For example, digital asset marketplace system 502 may transmit and/or buyer account 504 may receive a third instruction to transfer the selected amount of the cryptocurrency from the buyer account 504.

In some non-limiting embodiments or aspects, the third instruction may direct buyer account 504 (e.g., a digital wallet associated with the buyer) to transfer the cryptocurrency to the smart contract.

In some non-limiting embodiments or aspects, the third instruction may be communicated by at least one API. For example, digital asset marketplace system 502 may provide (e.g., communicate, make available, and/or the like) the API to buyer account 504 and/or a buyer system associated therewith.

As shown in FIG. 5, at step 518, implementation 500 may include generating a smart contract in a blockchain network. For example, digital asset marketplace system 502 may generate a smart contract within a blockchain network 108.

In some non-limiting embodiments or aspects, step 518 may occur after (e.g., in response to and/or based on) steps 514 and 516, as described herein. In some non-limiting embodiments or aspects, step 518 may occur before steps 514 and 516 (e.g., steps 514 and 516 may be in response to and/or based on step 518), as described herein.

In some non-limiting embodiments or aspects, the smart contract may determine (and/or receive evidence from buyer account 504) that sufficient funds are available from buyer account 504 to purchase the digital asset. Additionally or alternatively, the smart contract may determine (and/or receive evidence from seller account 506) that the digital asset is available to transfer.

In some non-limiting embodiments or aspects, the smart contract may be generated by at least one API. For example, digital asset marketplace system 502 may use (e.g., include, have access to, and/or the like) the API to generate the smart contract in the blockchain network (e.g., blockchain network 108).

As shown in FIG. 5, at step 520, implementation 500 may include transferring the digital asset to the smart contract, as described herein. For example, digital asset marketplace system 502 may transfer the digital asset from seller account 506 to the smart contract.

In some non-limiting embodiments or aspects, the digital asset may be transferred by at least one API. For example, digital asset marketplace system 502 may use (e.g., include, have access to, and/or the like) the API to transfer the digital asset.

As shown in FIG. 5, at step 522, implementation 500 may include transferring the cryptocurrency to the smart contract, as described herein. For example, digital asset marketplace system 502 may transfer the selected amount of the cryptocurrency from buyer account 504 to the smart contract.

In some non-limiting embodiments or aspects, the cryptocurrency may be transferred by at least one API. For example, digital asset marketplace system 502 may use (e.g., include, have access to, and/or the like) the API to transfer the currency.

In some non-limiting embodiments or aspects, transferring the selected amount of the cryptocurrency to the smart contract may include transferring a portion of the selected amount of the cryptocurrency from the buyer account 504 to the smart contract at each recurring period of a plurality of recurring periods within a duration.

As shown in FIG. 5, at steps 524-1 to 524-n, implementation 500 may include periodically transferring portions of the selected amount of the cryptocurrency from the smart contract to the seller account 506, as described herein. For example, digital asset marketplace system 502 and/or the smart contract may transfer a portion of the selected amount of the cryptocurrency from the smart contract to seller account 506 at each step from 524-1 to 524-n.

In some non-limiting embodiments or aspects, digital asset marketplace system 502 and/or the smart contract may determine that the smart contract has received has a sufficient amount of the cryptocurrency to transfer to the seller account 506 (e.g., at each period, such as each step from 524-1 to 524-n). Additionally or alternatively, digital asset marketplace system 502 and/or the smart contract may transfer a portion of the selected amount of the cryptocurrency to seller account 506 at each recurring period of a plurality of recurring periods within a duration (e.g., the duration may include n recurring periods).

In some non-limiting embodiments or aspects, the cryptocurrency may be transferred by at least one API. For example, digital asset marketplace system 502 may use (e.g., include, have access to, and/or the like) the API to transfer the currency.

As shown in FIG. 5, at steps 526a and 526b, implementation 500 may include transferring the digital asset to one of buyer account 504 (e.g., step 526a) or seller account 506 (e.g., step 526b). For example, if the portions of the selected amount of the cryptocurrency were transferred successfully at all periods in the duration (e.g., the entire selected amount of cryptocurrency has been transferred by the end of the duration), digital asset marketplace system 502 and/or the smart contract may transfer the digital asset to buyer account 504 (e.g., step 526a). Alternatively, if the portions of the selected amount of the cryptocurrency were not transferred successfully at at least one period (e.g., all periods, a subset of periods, and/or the like) in the duration (e.g., the entire selected amount of cryptocurrency has not been transferred by the end of the duration), digital asset marketplace system 502 and/or the smart contract may transfer the digital asset to seller account 506 (e.g., step 526b).

Although the present disclosure has been described in detail for the purpose of illustration based on what is currently considered to be the most practical and preferred embodiments or aspects, it is to be understood that such detail is solely for that purpose and that the present disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method, comprising:
receiving, with at least one processor, a first instruction to exchange a selected amount of a cryptocurrency from a buyer account for a digital asset from a seller account;
transmitting, with at least one processor, a second instruction to transfer the digital asset from the seller account;
transmitting, with at least one processor, a third instruction to transfer the selected amount of the cryptocurrency from the buyer account;
generating, with at least one processor, a smart contract within a first blockchain network associated with the cryptocurrency based on the second instruction to transfer the digital asset and the third instruction to transfer the selected amount of cryptocurrency;
transferring, with at least one processor, the selected amount of the cryptocurrency from the buyer account and the digital asset from the seller account to the smart contract;
transferring, with at least one processor, the selected amount of the cryptocurrency from the smart contract to the seller account;
generating, with at least one processor, a non-retrievable address; and
transferring, with at least one processor, the digital asset from the smart contract to the non-retrievable address.

2. The computer-implemented method of claim 1, further comprising:
generating, with at least one processor, a confirmation message indicating that the digital asset was transferred to the non-retrievable address; and
transmitting, with at least one processor, the confirmation message to the buyer account.

3. The computer-implement method of claim 1, wherein transferring the selected amount of the cryptocurrency from the smart contract to the seller account comprises:
determining that the smart contract has a sufficient amount of the cryptocurrency to transfer to the seller account; and
transferring a portion of the selected amount of the cryptocurrency from the smart contract to the seller at each recurring period of a plurality of recurring periods within a duration.

4. The computer-implemented method of claim 1, wherein transferring the selected amount of the cryptocurrency from the smart contract to the seller account comprises executing the smart contract within the first blockchain network associated with the cryptocurrency.

5. The computer-implemented method of claim 4, wherein the smart contract is associated with a target time period, the target time period comprising a duration of time from a first time that the smart contract is generated to a second time that the smart contract is executed.

6. The computer-implemented method of claim 1, wherein the non-retrievable address comprises an address on a second blockchain network.

7. The computer-implemented method of claim 1, wherein the non-retrievable address comprises a public address associated with the first blockchain network, wherein generating the non-retrievable address comprises:
generating the public address and a private key associated with the public address; and
discarding the private key.

8. A system comprising at least one processor programmed or configured to:
receive a first instruction to exchange a selected amount of a cryptocurrency from a buyer account for a digital asset from a seller account;
transmit a second instruction to transfer the digital asset from the seller account;
transmit a third instruction to transfer the selected amount of the cryptocurrency from the buyer account;
generate a smart contract within a first blockchain network associated with the cryptocurrency based on the second instruction to transfer the digital asset and the third instruction to transfer the selected amount of cryptocurrency;
transfer the selected amount of the cryptocurrency from the buyer account and the digital asset from the seller account to the smart contract;
transfer the selected amount of the cryptocurrency from the smart contract to the seller account;
generate a non-retrievable address; and
transfer the digital asset from the smart contract to the non-retrievable address.

9. The system of claim 8, wherein the at least one processor is further programmed or configured to:
generate a confirmation message indicating that the digital asset was transferred to the non-retrievable address; and
transmit the confirmation message to the buyer account.

10. The system of claim 8, wherein, when transferring the selected amount of the cryptocurrency from the smart contract to the seller account, the at least one processor is programmed or configured to:
determine that the smart contract has a sufficient amount of the cryptocurrency to transfer to the seller account; and
transfer a portion of the selected amount of the cryptocurrency from the smart contract to the seller at each recurring period of a plurality of recurring periods within a duration.

11. The system of claim 8, wherein, when transferring the selected amount of the cryptocurrency from the smart contract to the seller account, the at least one processor is programmed or configured to execute the smart contract within the first blockchain network associated with the cryptocurrency.

12. The system of claim 11, wherein the smart contract is associated with a target time period, the target time period comprising a duration of time from a first time that the smart contract is generated to a second time that the smart contract is executed.

13. The system of claim 8, wherein the non-retrievable address comprises an address on a second blockchain network.

14. The system of claim 8, wherein the non-retrievable address comprises a public address associated with the first blockchain network, wherein, when generating the non-retrievable address, the at least one processor is programmed or configured to:
generate the public address and a private key associated with the public address; and
discard the private key.

15. A computer program product comprising at least one non-transitory computer readable medium including one or more instructions that, when executed by at least one processor, cause the at least one processor to:
receive a first instruction to exchange a selected amount of a cryptocurrency from a buyer account for a digital asset from a seller account;
transmit a second instruction to transfer the digital asset from the seller account;
transmit a third instruction to transfer the selected amount of the cryptocurrency from the buyer account;
generate a smart contract within a first blockchain network associated with the cryptocurrency based on the second instruction to transfer the digital asset and the third instruction to transfer the selected amount of cryptocurrency;
transfer the selected amount of the cryptocurrency from the buyer account and the digital asset from the seller account to the smart contract;
transfer the selected amount of the cryptocurrency from the smart contract to the seller account;
generate a non-retrievable address; and
transfer the digital asset from the smart contract to the non-retrievable address.

16. The computer program product of claim 15, wherein the one or more instructions that cause the at least one processor to transfer the selected amount of the cryptocurrency from the smart contract to the seller account cause the at least one processor to:
determine that the smart contract has a sufficient amount of the cryptocurrency to transfer to the seller account; and
transfer a portion of the selected amount of the cryptocurrency from the smart contract to the seller at each recurring period of a plurality of recurring periods within a duration.

17. The computer program product of claim 15, wherein the one or more instructions that cause the at least one processor to transfer the selected amount of the cryptocurrency from the smart contract to the seller account cause the at least one processor to execute the smart contract within the first blockchain network associated with the cryptocurrency.

18. The computer program product of claim 17, wherein the smart contract is associated with a target time period, the target time period comprising a duration of time from a first time that the smart contract is generated to a second time that the smart contract is executed.

19. The computer program product of claim 15, wherein the non-retrievable address comprises an address on a second blockchain network.

20. The computer program product of claim 15, wherein the non-retrievable address comprises a public address associated with the first blockchain network, wherein generating the non-retrievable address comprises:
generating the public address and a private key associated with the public address; and
discarding the private key.
